(19) United States
(12) Patent Application Publication
(10) Pub. No.: US 2010/0320720 A1
(43) Pub. Date: Dec. 23, 2010

(54) Motion transfer mechanism for transferring reciprocal motion to rotary motion and rider-propelled vehicle utilizing motion transfer mechanism

(76) Inventors: Wilson X. Bezerra, Belleville, NJ (US); Silvana A. Bezerra, Belleville, NJ (US)

Correspondence Address: BRUCE L. ADAMS, ESQ.;ADAMS & WILKS, SUITE 1231, 17 BATTERY PLACE, NEW YORK, NY, 10004, US

(21) Appl. No.: 12/802,979

(22) Filed: Jun. 17, 2010

Related U.S. Application Data
(60) Provisional application No. 61/187,863, filed on Jun. 17, 2009.

(51) Int. Cl. B62M 1/04; F16D 41/00

(52) U.S. Cl. 280/252; 74/25

(57) ABSTRACT

A motion transfer mechanism for transferring reciprocal motion to rotary motion. The motion transfer mechanism comprises at least one driving member configured to undergo reciprocal motion about a first axis and at least one clutch housing integral with the at least one driving member and configured to undergo angular displacement about the first axis during reciprocal motion of the at least one driving member. A driven member supports the at least one clutch housing and is mounted to undergo rotary motion in a direction of rotation about the first axis. At least one unidirectional clutch mechanism is mounted on the driven member and is configured to engage the at least one clutch housing for effecting rotation of the driven member in the direction of rotation during reciprocal motion of the at least one driving member.

### CROSS-REFERENCE TO RELATED APPLICATIONS

The present application for patent claims priority benefit of Provisional Application Ser. No. 61/187,863, filed Jun. 17, 2009. This provisional patent application is hereby expressly incorporated by reference herein in its entirety.

### BACKGROUND OF THE INVENTION

1. Field of the Invention

The present invention relates generally to motion transfer mechanisms and, more particularly, to a motion transfer mechanism for transferring reciprocal motion to rotary motion and which is particularly suited for rider-propelled vehicles.

2. Background of the Invention

Over the years, a wide variety of rider-propelled vehicles have been devised. Among the more popular rider-propelled vehicles are three-wheeled vehicles known as tricycles that include a frame, a front wheel and a pair of rear wheels carried on the frame, a seat for the operator, a steering handle to steer the tricycle, and rotary pedals for propelling the tricycle. Ordinarily, the front wheel is steered by hand-operation, while the front wheel (driven wheel) is propelled by circular peddling motion of the pedals.

Although this circular peddling motion is effective in creating sufficient force to propel the vehicle forward, it does not do so efficiently. The circular peddling motion required to propel the driven wheel of the conventional tricycle forward results in lost motion and wasted energy. The driving force that propels the conventional tricycle is developed from the outward and/or downward extension of the rider's legs and feet (relative to the seating and pedal positions) along part of the circular path of travel of the pedals, and the circular path makes it difficult for the rider to exert a constant propulsive force. As a result, the rider is not able to optimize the results of their energy expenditure which is especially significant during a long journey. Additionally, the smoothness of operation of the tricycle is compromised since the transmission of force depends on the position of the pedals during their cycle of rotation, resulting in non-uniform transmission of force. Since the non-uniformity of the force transmission is independent of the speed of the vehicle, the non-uniformity is especially pronounced at low speeds.

Another problem with the aforementioned conventional tricycles is that the pedals are driven in a circular motion with vertical and horizontal force components, thereby making the application of force to the pedals inefficient. As a result, a rider utilizes only a small portion of his body weight during propulsion of the vehicle. Therefore, the conventional tricycles, in which rotary motion of the pedals is converted to rotary motion of the driven wheel have the drawbacks of ineffective transmission of force, poor mechanical advantage, low power output and high resistance, and require the application of substantial force in order for the rider to propel the tricycle, particularly when starting up or accelerating.

When the rider of the conventional tricycle is a young child, he/she may not be able to ride the tricycle because his/her legs may be too short, he/she does not have any power to turn the pedals, and/or he/she cannot reach the pedal. The current existing tricycles make it very difficult for a very young child to turn the pedals to propel the tricycle. As a result, children tend to get tired of playing with it easily.

Conventional rider-propelled vehicles driven by reciprocal upward and downward motion of levers have been proposed. However, the transmission of the reciprocal motion of the levers to drive the rider-propelled vehicle has not been satisfactory. In particular, most conventional rider-propelled vehicles are designed for use only by relatively strong and agile persons. As a consequence, such conventional rider-propelled vehicles have certain features which render them difficult or impractical to use by many persons, including persons having less than average agility or strength, such as the elderly, young children, and children with special needs.

The present invention provides a motion transfer mechanism, particularly suited for rider-propelled vehicles, for transferring reciprocal motion to rotary motion in a manner which avoids the foregoing drawbacks and disadvantages of prior constructions.

### SUMMARY OF THE INVENTION

It is an object of the present invention to provide a motion transfer mechanism for transferring reciprocal motion to rotary motion in a simple and efficient manner and which is particularly suited for rider-propelled vehicles.

It is another object of the present invention to provide a motion transfer mechanism wherein reciprocal motion applied to pivoted levers or crank arms is effectively transferred to rotary motion of a driven member without requiring the application of substantial force.

It is another object of the present invention to provide a motion transfer mechanism for transferring reciprocal motion to rotary motion to propel a rider-propelled vehicle, characterized by a smooth and uniform transmission of force independent of the speed of the vehicle.

It is another object of the present invention to provide a motion transfer mechanism for transferring reciprocal motion to rotary motion to propel a rider-propelled vehicle, in which the transmission of force and the mechanical advantage are improved to reduce the effort which must be expended by the rider.

It is still another object of the present invention to provide a motion transfer mechanism for transferring reciprocal motion to rotary motion, wherein reciprocal motion of a pair of pivotal levers or crank arms is transferred to rotary motion to propel a rider-propelled vehicle with efficient transfer of applied power and reduced resistance to power transfer.

It is yet another object of the present invention to provide an improved rider-propelled vehicle, such as a tricycle, that is easy to operate by persons having less than average agility or strength, such as the elderly, young children, and children with special needs.

The foregoing and other objects of the present invention are carried out by a motion transfer mechanism for transferring reciprocal motion to rotary motion, the motion transfer mechanism comprising at least one driving member configured to undergo reciprocal motion about a first axis, at least one clutch housing integral with the at least one driving member and configured to undergo angular displacement about the first axis during reciprocal motion of the at least one driving member, a driven member supporting the at least one clutch housing and mounted to undergo rotary motion in a direction of rotation about the first axis, and at least one unidirectional clutch mechanism mounted on the driven member and configured to engage the at least one clutch housing for effecting rotation of the driven member in the direction of rotation during reciprocal motion of the at least one driving member.

In another aspect, a motion transfer mechanism for transferring reciprocal motion to rotary motion comprises a pair of driving members configured to undergo reciprocal motion about a first axis, a pair of clutch housings configured to undergo angular displacement about the first axis during reciprocal motion of the respective driving members, a driven member mounted to undergo rotary motion in first and second opposite directions of rotation about the first axis, a first unidirectional clutch mechanism configured to engage the clutch housings for effecting rotation of the driven member in only the first direction of rotation during reciprocal motion of the driving members, and a second unidirectional clutch mechanism configured to engage the clutch housings for effecting rotation of the driven member in only the second direction of rotation during reciprocal motion of the driving members.

In an exemplary embodiment, the first unidirectional clutch mechanism is mounted on and is drivingly engaged with the driven member for undergoing rotary motion about the first axis during reciprocal motion of the driving members to effect rotation of the driven member in only the first direction of rotation. The second unidirectional clutch mechanism is mounted on and is drivingly engaged with the driven member for undergoing rotary motion about the first axis during reciprocal motion of the driving members to effect rotation of the driven member in only the second direction of rotation.

Each of the first and second unidirectional clutch mechanisms of the exemplary embodiment comprises a pair of clutch rings each having a clutch element and a cylindrical friction block disposed within the clutch ring and integrally mounted on the driven member for rotation therewith. The clutch rings of the first unidirectional clutch mechanisms are configured for engagement with the respective clutch housings of the driving members in a first clutch engagement mode for effecting rotation of the driven member in only the first direction of rotation during reciprocal motion of the driving members. The clutch rings of the second unidirectional clutch mechanisms are configured for engagement with the respective clutch housings of the driving members in a second clutch engagement mode for effecting rotation of the driven member in only the second direction of rotation during reciprocal motion of the driving members.

The driven member of the exemplary embodiment comprises a shaft having a plurality of recesses formed in an outer surface thereof and a plurality of ratchet keys protruding from and integrally mounted in the respective recesses for rotation with the shaft. The friction blocks of the first and second unidirectional clutch mechanisms are integrally mounted on the respective ratchet keys of the shaft for undergoing rotation with the shaft about the first axis and for undergoing sliding movement along the respective ratchet keys in the direction of the first axis.

According to another feature of the invention, the motion transfer mechanism further comprises a clutch transfer mechanism for switching between the first clutch engagement mode and the second clutch engagement mode. The clutch transfer mechanism comprises a transfer member mounted to undergo linear movement in opposite directions along a second axis disposed generally parallel to the first axis. The transfer member has a plurality of engaging portions engaging with complementary engaging portions of the respective clutch rings of the first and second unidirectional clutch mechanisms so that movement of the transfer member in one direction to a first position along the second axis causes the clutch rings of the first unidirectional clutch assembly to slide along the respective ratchet keys and engage the respective clutch housings of the driving members, and so that movement of the transfer member in the opposite direction to a second position along the second axis causes the clutch rings of the second unidirectional clutch assembly to slide along the respective ratchet keys and engage the respective clutch housings of the driving members.

The clutch transfer mechanism preferably comprises a biasing member for biasing the transfer member to the first position, and a mechanism for selectively moving the transfer member from the first position to the second position.

In yet another aspect, the present invention is directed to rider-propelled vehicle comprising a frame, a pair of driving members mounted on the frame to undergo reciprocal motion about a first axis, a pair of clutch housings connected to the respective driving members for undergoing angular displacement about the first axis during reciprocal motion of the respective driving members, a driven member mounted on the frame to undergo rotary motion in first and second opposite directions of rotation about the first axis, a first unidirectional clutch mechanism mounted on the driven member and configured to engage the clutch housings for effecting rotation of the driven member in only the first direction of rotation during reciprocal motion of the driving members, and a second unidirectional clutch mechanism mounted on the driven member and configured to engage the clutch housings for effecting rotation of the driven member in only the second direction of rotation during reciprocal motion of the driving members.

These and other features, aspects and advantages of the present invention will become better understood with reference to the following drawings, description and claims.

### BRIEF DESCRIPTION OF THE DRAWINGS

The foregoing summary, as well as the following detailed description of the preferred embodiment of the invention, will be better understood when read in conjunction with the accompanying drawings. For the purpose of illustrating the invention, there is shown in the drawings an embodiment which is presently preferred. It should be understood, however, that the invention is not limited to the precise arrangements and instrumentalities shown. In the drawings:

FIG. 1 is a perspective view of an exemplary embodiment of a rider-propelled vehicle incorporating a motion transfer mechanism for transferring reciprocal motion to rotary motion according to the present invention;

FIG. 2 is a perspective view of the rider-propelled vehicle of FIG. 1 with a rear box cover off;

FIG. 3 is a partial exploded perspective view of the rider-propelled vehicle shown in FIG. 1;

FIG. 4 is a side view of the rider-propelled vehicle shown in FIG. 1;

FIG. 5 is a partial rear view of the rider-propelled vehicle shown in FIG. 2;

FIG. 6 is a partial rear view of the rider-propelled vehicle shown in FIG. 2 illustrating the clutch system engaged in a state for propelling the rider-propelled vehicle forward;

FIG. 7 is a partial rear view of the rider-propelled vehicle shown in FIG. 2 illustrating the clutch system engaged in a state for propelling the rider-propelled vehicle in reverse;

FIG. 8 is a partial rear view illustrating the pulley and pedal system of the rider-propelled vehicle according to the present invention;

FIG. 9 is a partial rear view illustrating the braking system, in a disengaged state, of the rider-propelled vehicle according to the present invention;

FIG. 10 is a partial rear view illustrating the braking system, in an engaged state, of the rider-propelled vehicle according to the present invention;

FIG. 11 is a partial front view showing connecting states between the clutch lever, transfer member, clutch rings and ratchet keys in a state for propelling the rider-propelled vehicle according to the present invention forward; and

FIG. 12 is a partial cross-sectional rear view showing connecting states between the transfer member, clutch rings and ratchet keys in a state for propelling the rider-propelled vehicle according to the present invention forward.

### DETAILED DESCRIPTION OF THE PREFERRED EMBODIMENT

While this invention is susceptible of embodiments in many different forms, this specification and the accompanying drawings disclose only a specific form as an example of the use of the invention. The invention is not intended to be limited to the embodiment so described, and the scope of the invention will be pointed out in the appended claims.

The preferred embodiment of the motion transfer mechanism according to the present invention is described below with a specific application to a rider-propelled vehicle, particularly a tricycle. However, it will be appreciated by those of ordinary skill in the art that the following preferred embodiment of the motion transfer mechanism is also particularly well adapted for other rider-propelled vehicles such as, for example, bicycles, paddle boats, hydrobikes, small aircraft, wheelchairs and skateboards. It will also be appreciated by those of ordinary skill in the art that the preferred embodiment described below is not limited for specific use in rider-propelled vehicles, but may also be employed in other apparatus requiring the transfer of reciprocal motion to rotary motion. For example, the motion transfer mechanism of the present invention is also particularly well adapted for exercise apparatus such as, for example, stair climbers, treadmills and other physical conditioning devices.

Certain terminology is used in the following description for convenience only and is not intended to be limiting. The words right, left, front, rear, upper, lower, inner, outer, rearwardly, forwardly, clockwise and counterclockwise designate directions in the drawing to which reference is made. Such terminology includes the words above specifically mentioned and words of similar import.

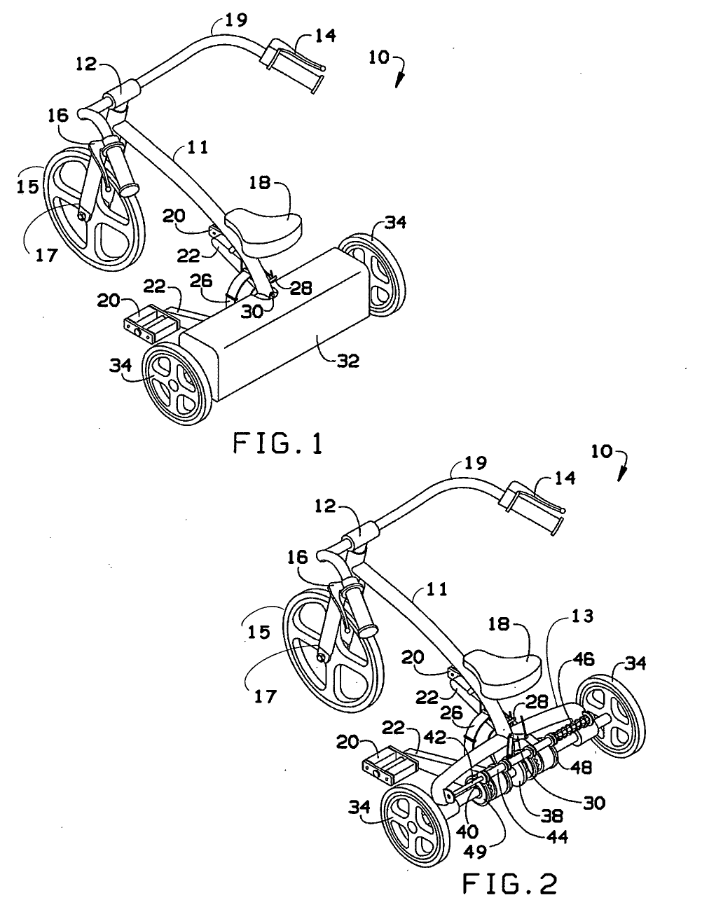

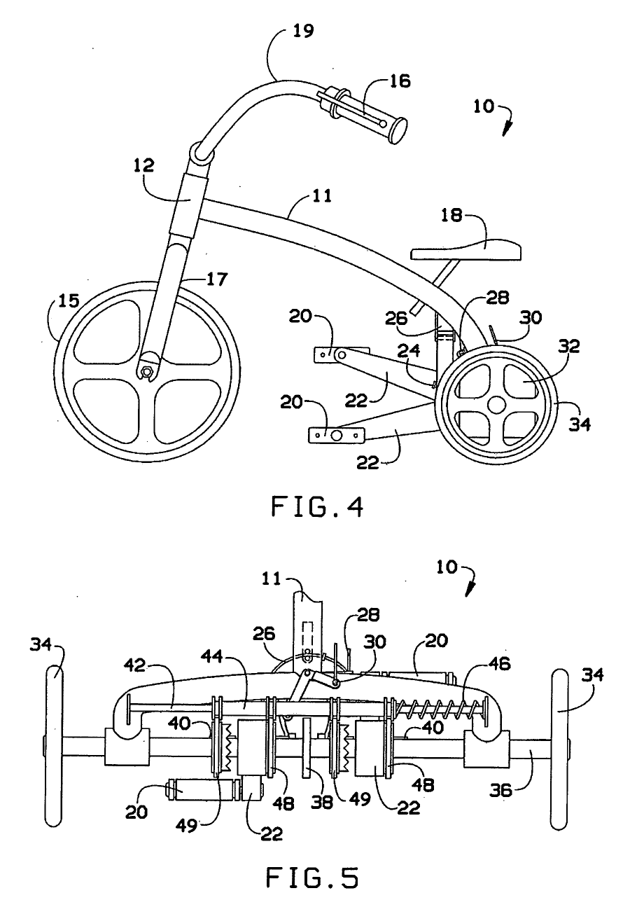

Referring now to the drawings in detail, wherein like numerals are used to indicate like elements throughout, there is shown in FIGS. 1-12 an exemplary embodiment of a motion transfer mechanism according to the principles of the present invention, employed in a tricycle, generally designated at 10. As shown in FIG. 1, the tricycle 10 has a frame which includes a downtube 11, a head tube 12 connected to one end of the downtube 11, and a cross tube 13 connected to another end of the downtube 11. A front wheel 15 of conventional type is journalled in a front fork 17 that extends from and is integral with the head tube 12. A handle bar 19 is connected to the front fork 17 via the head tube 12 for manual steering of the front wheel 15 and a seat, such as a saddle 18, is mounted atop the downtube 11. A rotary shaft or axle 36 (driven member) is mounted to opposite end portions 13a of the crosstube 13 for undergoing rotational movement in opposite directions of rotation, and rear wheels 34, also of conventional form, are mounted on respective opposite ends of the axle 36 for rotation therewith.

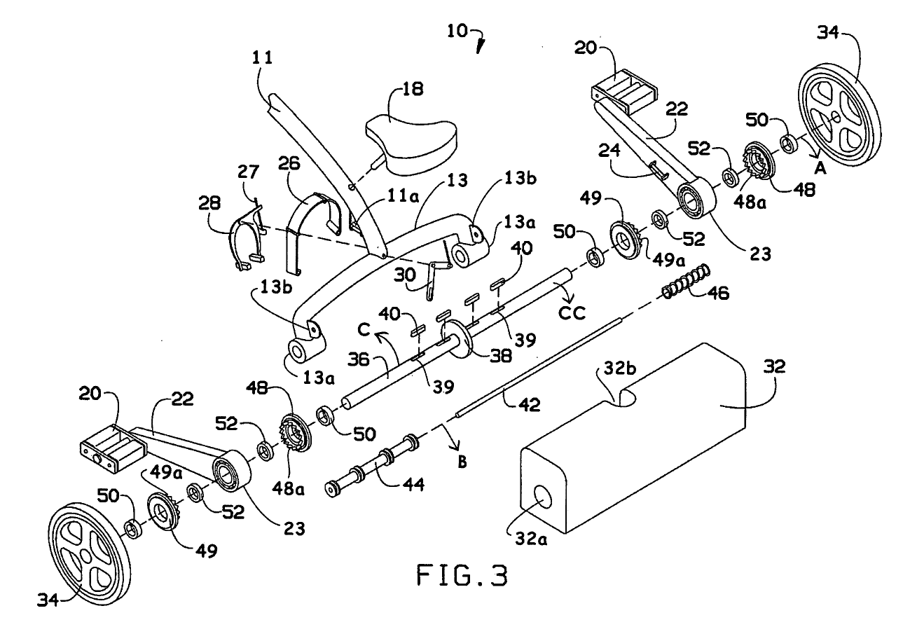

The tricycle 10 includes a brake mechanism for performing a braking operation. As best shown in FIGS. 3, 9 and 10, the brake mechanism comprises a hand brake lever 14, a brake assembly 28, and a generally disc-shaped braking member 38. The braking member 38 is mounted on a generally central portion of the axle 36 for rotation therewith. The brake assembly (e.g., a side pull caliper brake) 28 is mounted to the frame proximate a junction between the downtube 11 and the cross tube 13 for engaging braking member 38 during a breaking operation. The hand, brake lever 14 is pivotally coupled to a grip mounted on a handle portion of the handlebar 19 for permitting the rider to activate the brake assembly 28 to engage the braking member 38 during a braking operation. The brake lever 14 is connected in a conventional manner to the brake assembly 28 with a brake cable 27. FIG. 9 shows the state in which the brake mechanism is not engaged. FIG. 10 shows the state of a breaking operation in which the brake mechanism is engaged (i.e., the brake assembly 28 engages the braking member 38).

The frame components for the tricycle 10 are preferably formed of aluminum, titanium or chromium-molybdenum alloy, such as that marketed under the trademark CHROMALLY. However, it will be understood by those skilled in the art that other materials, such as carbon fibers and composite materials, which exhibit high strength and light weight characteristics are suitable for the frame components.

FIGS. 1-8 show assembled and exploded views of the motion transfer mechanism mounted on the frame of the tricycle 10. A housing 32, formed of a metal, high grade plastic, carbon fibers or composite materials, houses some of the mechanics of the drive unit of the motion transfer mechanism. The housing 32 is mounted to the downtube 11 and cross tube 13 of the frame such that the axle 36 passes through oppositely aligned openings 32a of the housing so as to allow the axle 36 to undergo rotational movement freely relative to the housing. A generally U-shaped recess or notch 32b is formed on one side of the housing 36 to accommodate a portion of the downtube 11 proximate a junction between the downtube 11 and the cross tube 13 in a mounted state of the housing (FIG. 1).

Left and right driving members or crank arms having front and rear end portions terminating, respectively, in front end rear ends, are coupled to the frame via a return mechanism and to the axle 36 of the tricycle 10 for up-and-down alternate reciprocal motion during use of the tricycle 10. Specifically, each crank arm comprises a pedal crank 22, a foot engaging surface 20 at the front end portion of the pedal crank, and a clutch housing 23 (rotary member) at the rear end portion of the pedal crank. In this embodiment, the foot engaging surface 20 is a pedal mounted to the front end portion of the pedal crank so that it is able to freely pivot independently on the pedal crank. The clutch housings 23 of the crank arms are mounted on the axle 36 via respective bearings 52 for undergoing pivotal movement about a first or pivoting axis A extending along an axial direction of the axle. Preferably, the pedal cranks 22 are formed of aluminum and have a hollow construction. However, it is understood by those skilled in the art that other constructions and materials are suitable for the pedal cranks 22. For example, the pedal cranks may be of solid construction and formed of other materials exhibiting a high ratio of strength to weight, such as a metal matrix, carbon fibers or composite materials.

In order to facilitate alternate reciprocal motion of the crank arms during use of the tricycle 10, the crank arms are coupled together to undergo synchronous movement by the return mechanism. As best shown in FIGS. 3 and 8, in the present embodiment the return mechanism is in the form of a pulley-and-cable arrangement in which a pulley-like structure 11a is secured to the down tube 11 of the frame and a cable 26 is connected at one end to an attachment portion 23 of one of the pedal cranks 22 and passes up over the pulley-like structure 11a and then downwardly and is connected at its other end to an attachment portion 23 of the other pedal crank 22. By such an arrangement, when the left crank arm 22 is moved downwardly, the right crank arm will be synchronously raised, and when the right crank arm is moved downwardly, the left crank arm will be synchronously raised. It will be appreciated by those skilled in the art that other lever return mechanisms which facilitate the alternate reciprocal motion of the crank arms during use of the tricycle may be used without departing from the spirit and scope of the invention.

The crank arms are interconnected with a drive unit mounted on the frame of the tricycle 10 which transfers reciprocal up-and-down motion of the crank arms about the first axis A to rotational motion of the axle 36, and thus the rear wheels 34, in opposite directions of rotation to propel the tricycle in respective forward and reverse directions. Details of the components of the drive unit according to the present embodiment for converting reciprocal up-and-down motion of the crank arms to rotational motion of the rear wheels 34 of the tricycle 10 will be described with reference to FIGS. 2, 3, 5-7 and 11-12 as set forth below.

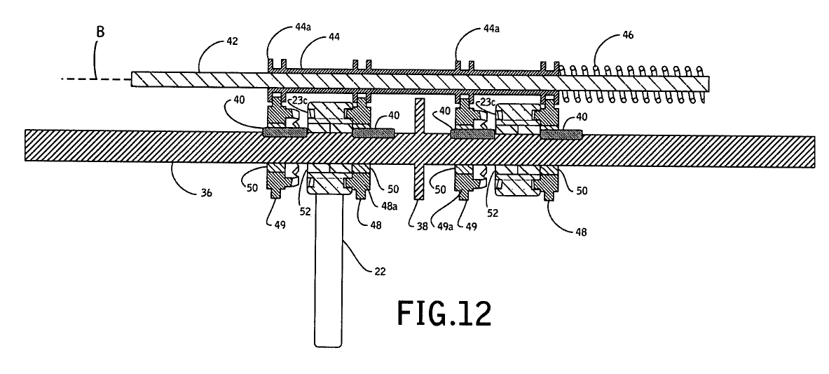

Left and right forward (first) unidirectional clutch mechanims or assemblies encircle the axle 36 for effecting rotation of the axle 36 only in a first direction of rotation (clockwise direction C as viewed in FIG. 3) which in turn rotates the rear wheels 34 in the first direction of rotation to propel the tricycle forward. More specifically, as shown in FIG. 12, each of the forward unidirectional clutch assemblies comprises a clutch ring 48 with a clutch element and a cylindrical friction block or ratchet 50 disposed within the clutch ring 48 so that the clutch element surrounds an outer circumferential surface of the ratchet. For each forward unidirectional clutch assembly, the clutch element of the clutch ring 48 is configured to move into and out of engagement with the ratchet 50 depending on the direction of angular displacement of the clutch ring, as well known in the clutch art. In this embodiment, for each forward unidirectional clutch assembly, angular displacement of the clutch ring 48 in the first direction of rotation causes the clutch element to impart a rotational drive force to the ratchet 50 in the first direction of rotation, whereas angular displacement of the clutch ring in a second direction of rotation (counterclockwise CC as viewed in FIG. 3) causes the clutch element to slip freely around the outer circumferential surface of the ratchet 50 so that no drive force is transmitted to the ratchet 50 in the second direction of rotation.

The axle 36 has four recesses 39 formed in an outer circumferential surface, two formed on a first side of the braking member 38 and two formed on a second side of the braking member opposite the first side. Each recess 39 accommodates a key element or ratchet key 40 so that a portion of the ratchet key protrudes from the surface of the axle 36. The ratchet keys 40 are integrally mounted in the respective recesses 39 of the axle 36 for rotation therewith. The two ratchets 50 of the forward unidirectional clutch assemblies are drivingly engaged with two of the ratchet keys 40, i.e., one located on the first side and one located on the second side of the braking member 38, so that the ratchets 50 and corresponding keys 40 undergo rotation as a unit when the corresponding clutch ring 48 is displaced angularly in the first direction of rotation. The ratchets 50 are also mounted on the respective keys 40 for undergoing limited relative sliding movement along the keys (i.e., along the first direction A) to permit the clutch rings 48 to be moved into driving engagement with the respective clutch housings 23 of the crank arms as further described below.

Left and right reverse (second) unidirectional clutch mechanisms or assemblies encircle the axle 36 for effecting rotation of the axle 36 only in the second direction of rotation which in turn rotates the rear wheels 34 in the second direction of rotation to propel the tricycle rearward or in reverse. More specifically, as shown in FIG. 12, each of the reverse unidirectional clutch assemblies comprises a clutch ring 49 with a clutch element and a cylindrical friction block or ratchet 50 disposed within the clutch ring 49 so that the clutch element surrounds an outer circumferential surface of the ratchet. For each reverse unidirectional clutch assembly, the clutch element of the clutch ring 49 is configured to move into and out of engagement with the ratchet 50 depending on the direction of angular displacement of the clutch ring, as well known in the clutch art. In this case, for each reverse unidirectional clutch assembly, angular displacement of the clutch ring 49 in the second direction of rotation causes the clutch element to impart a rotational drive force to the ratchet 50 in the second direction of rotation, whereas angular displacement of the clutch ring 49 in the first direction of rotation causes the clutch element to slip freely around the outer circumferential surface of the ratchet 50 so that no drive force is transmitted to the ratchet 50 in the first direction of rotation.

The two ratchets 50 of the reverse unidirectional clutch assemblies are drivingly engaged with the other two of the ratchet keys 40, i.e., the other key located on the first side and the other key located on the second side of the braking member 38, so that the ratchets 50 of the reverse unidirectional clutch assemblies and corresponding ratchet keys 40 undergo rotation as a unit when the corresponding clutch ring 48 is displaced angularly in the second direction of rotation. The ratchets 50 of the reverse unidirectional clutch assemblies are also mounted on the respective keys 40 for undergoing limited sliding movement relative to the keys to permit the clutch rings 49 to be moved into driving engagement with the respective clutch housings 23 of the crank arms.

As shown in FIG. 12, the clutch rings 48, 49 are provided with toothed circumferential outer peripheries 48a, 49a, respectively, for driving engagement with complementary tooth portions provided in grooves 23a formed on opposite sides of the clutch housings 23 of the corresponding left and right crank arms. By this construction, the clutch rings 48, 49 of the left forward and reverse unidirectional clutch assemblies, respectively, are configured to be alternately drivingly engaged with and disengaged from the clutch housing 23 of the left crank arm. Likewise, clutch rings 48, 49 of the right forward and reverse unidirectional clutch assemblies, respectively, are configured to be alternately drivingly engaged with and disengaged from the clutch housing 23 of the right crank arm.

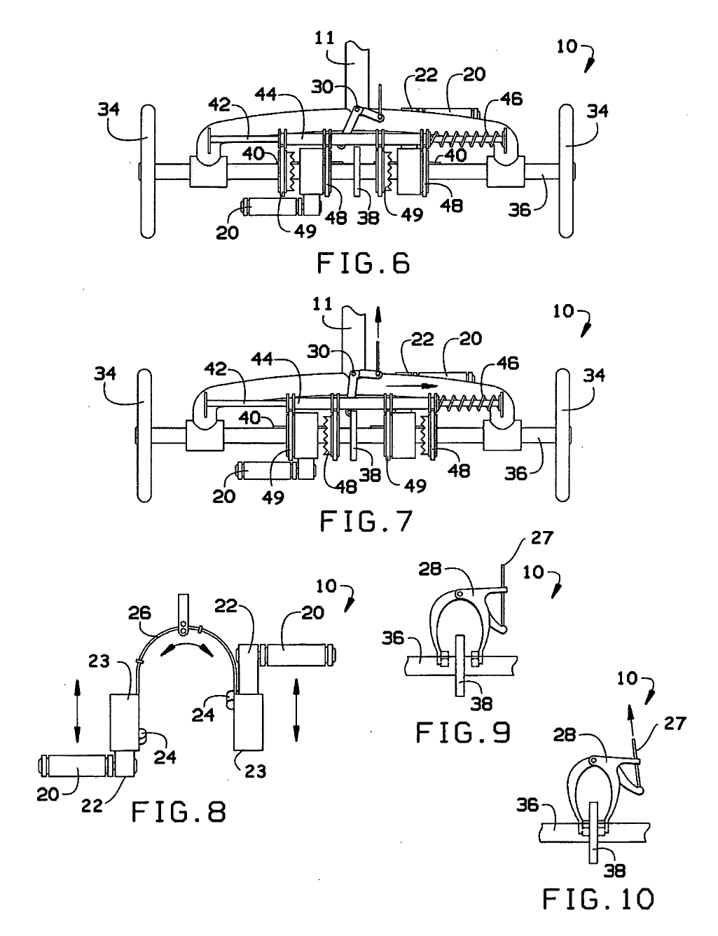

Thus, in a first clutch engagement mode of the tricycle, as shown in FIG. 6, the clutch rings 48 of the forward unidirectional clutch assemblies are drivingly engaged with the respective clutch housings 23 of the crank arms. In this first clutch engagement mode, reciprocal up-and-down movement of the crank arms effects angular displacement of the clutch rings 48, and this angular displacement is transmitted to the axle 36, via the corresponding ratchet keys 40, by releasable clutching engagement of the clutch elements with the respective ratchets 50 to thereby rotate the axle 36, and thus the rear wheels 34, in the first direction to propel the tricycle forward. On the other hand, in a second clutch engagement mode of the tricycle, as shown in FIG. 7, the clutch rings 49 of the reverse unidirectional clutch assemblies are drivingly engaged with the respective clutch housings 23 of the crank arms. In this second clutch engagement mode, reciprocal up-and-down movement of the crank arms effects angular displacement of the clutch rings 49, and this angular displacement is transmitted to the axle 36, via the corresponding ratchet keys 40, by releasable clutching engagement of the clutch elements with the respective ratchets 50 to thereby rotate the axle 36, and thus the rear wheels 34, in the second direction to propel the tricycle in reverse, i.e., rearwardly.

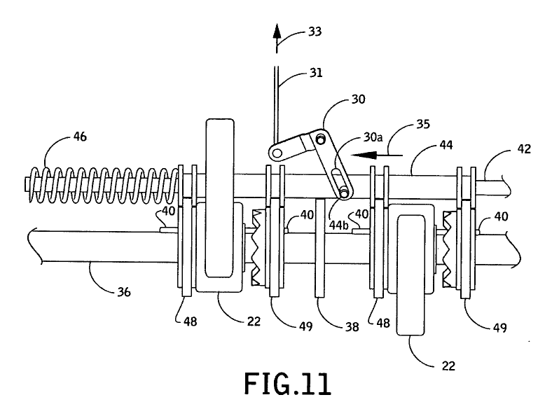

FIGS. 3 and 11 illustrate a clutch transfer mechanism for switching or transferring the tricycle between the first and second clutch engagement modes. The clutch transfer mechanism includes a shaft 42 integrally connected at opposite ends thereof to mounting portions 13b of the crosstube 13 and extending along a second axis B disposed generally parallel to the first axis A. A transfer member 44 is mounted over an outer circumferential portion of the shaft 42 in concentric relation to one another so as to allow the transfer member to slide in left and right directions (as viewed in FIG. 12) relative to the shaft (i.e., along the first axis A). The transfer member 44 has four circumferential grooved shoulders 44a that engage respective circumferential key portions of the clutch rings 48, 49 in a key-and-groove fashion. Sliding movement of the transfer member 44 in the left and right directions relative to the shaft 42 causes the clutch rings, and corresponding clutch elements and ratchets 50, to slide over the corresponding ratchet keys 40 to switch the tricycle between the first and second clutch engagement modes.

Referring to FIGS. 3, 6, 7, 11 and 12, sliding movement of the transfer member 44 relative to the shaft 42 is effected by means of a generally L-shaped clutch member 30 that is pivotally mounted by conventional mounting means to the frame proximate a junction between the downtube 11 and cross tube 13. As best shown in FIG. 11, the clutch member 30 has a first leg portion with a slot 30a that engages a pin 44b extending from the outer circumferential surface of the transfer member 44, and a second leg portion operatively connected to one end of a clutch wire 31. The other end of the clutch wire 31 is operatively connected to a hand clutch lever 16 (FIG. 1) pivotally coupled to a grip mounted on a handle portion of the handle bar 19 other than the handle portion on which the hand brake lever 14 is mounted. FIGS. 6, 11 and 12 show the first clutch engagement mode in which the left and right forward unidirectional clutch assemblies engage the respective crank arms for propelling the tricycle forward as described above. A spring 46 is mounted over an outer circumferential portion of the shaft 42 and is interposed between one of the portions 13b of the cross tube 13 and an end of the transfer member so as to bias the transfer member 44 in the direction denoted by arrow 35 in FIG. 11 (i.e., left direction) to maintain the tricycle in the first clutch engagement mode. Stated otherwise, by means of the biasing action of the spring 46, the tricycle is normally in the first clutch engagement mode (i.e., the default clutch engagement mode) for propelling the tricycle forward and remains in this mode until the hand clutch lever 16 operated. Thus, operation of the hand clutch lever 16 pulls the clutch wire 31 in the direction of arrow 33 in FIG. 11 to cause the clutch member 30 to pivot in a clockwise direction (as viewed in FIG. 11) to slide the transfer member 44 in the direction of arrow 35 in FIG. 11 to transfer the tricycle to the second clutch engagement mode in which the left and right reverse unidirectional clutch assemblies engage the respective crank arms for propelling the tricycle in reverse. This second clutch engagement mode is shown in FIG. 7.

It will be appreciated from the above construction of the motion transfer mechanism of the present embodiment that the axle 36, clutch housings 23 of the crank arms, clutch rings 48, 49 and corresponding clutch elements and ratchets 50 are all coaxial with the first axis A which is defined by the center axis of the axle 36. This feature advantageously provides for a compact and dynamically balanced motion transfer mechanism.

In operation, while the tricycle is in the first clutch engagement mode (i.e., the default clutch engagement mode) shown in FIGS. 5-6 and 11-12, alternate actuation of the crank levers by the rider in a downward direction about the first axis A defined by the axle 36 alternately pivots or effects angular displacement of the clutch rings 48, and this angular displacement is transmitted to the axle 36, via the corresponding ratchet keys 40, by releasable clutching engagement of the clutch elements with the respective ratchets 50 to thereby continuously rotate the axle 36, and thus the rear wheels 34, in the first direction to propel the tricycle forward. On the other hand, upward motion of the crank arms is not transmitted to the axle 36. Instead, during the upward strokes of the crank arms, the forward unidirectional clutch assemblies de-clutch or disengage the clutch elements of the clutch rings 48 from the ratchets 50 so that the angular displacement of the clutch rings 48 in the second direction of rotation is not transmitted to the axle 36. Stated otherwise, the forward unidirectional clutch assemblies freewheel relative to the axle 36 when the clutch rings 48 are angularly displaced in the second (clockwise) direction of rotation.

From the first clutch engagement mode as described above, the tricycle is switched to the second clutch engagement mode, as shown in FIG. 7, by operation of the hand clutch lever 16 as described above. While in the second clutch engagement mode, alternate actuation of the crank levers by the rider in a downward direction about the first axis A defined by the axle 36 alternately pivots or effects angular displacement of the clutch rings 49, and this angular displacement is transmitted to the axle 36, via the corresponding ratchet keys 40, by releasable clutching engagement of the clutch elements with the respective ratchets 50 to thereby continuously rotate the axle 36, and thus the rear wheels 34, in the second direction to propel the tricycle in reverse. On the other hand, upward motion of the crank arms is not transmitted to the axle 36. Instead, during the upward strokes of the crank arms, the reverse unidirectional clutch assemblies de-clutch or disengage the clutch elements of the clutch rings 49 from the ratchets 50 so that the angular displacement of the clutch rings 49 in the first direction of rotation is not transmitted to the axle 36. Stated otherwise, the reverse unidirectional clutch assemblies freewheel relative to the axle 36 when the clutch rings 49 are angularly displaced in the first (counterclockwise) direction of rotation.

The axle 36, ratchet keys 40, shaft 42, transfer member 44, clutch rings 48, 49 and ratchets 50 are preferably formed of titanium or steel. The clutch elements of the clutch rings 48, 49 are preferably formed of hardened chrome steel. However, it will be understood by those of ordinary skill in the art that other materials are suitable for the components of the drive unit. For example, some or all of the components of the drive unit may be formed of a metal matrix or assorted variations of steel which exhibit a high ratio of strength to weight.

It will be understood that the dimensions of the frame of the tricycle in the foregoing embodiment are selected so that the rider, seated upon the seat 18, can conveniently reach and apply a driving force to the forward ends of the crank arms. The overall length of the tricycle may be kept within the prescribed limits for tricycles.

It will be appreciated that as a result of coupling the crank arms through the crank arm return mechanism as described above and shown in FIG. 8, for example, the reciprocal back-and-forth motions of the crank arms are synchronized with each other, facilitating alternate reciprocal motion of the crank arms during use of the tricycle. By this arrangement and operation, it will be appreciated that reciprocal up-and-down motion of the crank arms by a rider will drive the rear wheels of the tricycle in the first direction of rotation to propel the tricycle forwardly, when the tricycle is in the first clutch engagement mode shown in FIGS. 5-6 and 11-12, and will drive the rear wheels 34 of the tricycle in the second direction of rotation to propel the tricycle in reverse, when the tricycle is in the second clutch engagement mode shown in FIG. 7. It will therefore be appreciated that the unidirectional drive of the axle 36 either forwardly or in reverse provides for the stepping drive of the tricycle in which the driving action is accomplished with a more efficient (e.g., smooth and uniform) transmission of force independent of the speed of the tricycle as compared, for example, with the average force delivered in the case of a conventional tricycle. Thus, the present invention provides a tricycle that is easy to operate by persons having less than average agility or strength, such as the elderly, young children, and children with special needs.

It will also be appreciated by those skilled in the art that the crank arms of the tricycle leverages the weight of the rider and the crank arm return mechanism helps the crank arms with the up and down motion. This allows a rider to stand up while riding the tricycle, and allows the rider to utilize the walking muscles.

Moreover, in the simplified construction of the motion transfer mechanism according to the invention, the reciprocal up-and-down motion of the crank arms to propel the tricycle forward or in reverse is accomplished without substantially increasing the overall size and weight of the tricycle. A compact and dynamically balanced motion transfer mechanism is achieved by disposing the components of the forward and reverse unidirectional clutch assemblies within the housing 32 and by disposing the axle 36, clutch housings 23 of the crank arms, clutch rings 48, 49 and corresponding clutch elements, and ratchets 50 all coaxial with the first axis A which is defined by the center axis of the axle 36. In addition to the foregoing features, it will be understood that the stroke of the crank arms is not confined to any specific value. Thus, a rider could use various short strokes or could use the full stroke of each crank arm. This advantage is in part a consequence of utilizing left and right forward and reverse unidirectional clutch assemblies for driving the axle which in turn drives, for example, the rear wheels of the tricycle.

From the foregoing description, it can be seen that the present invention comprises an improved motion transfer mechanism for transferring reciprocal motion to rotary motion and to a rider-propelled vehicle utilizing the improved motion transfer mechanism. It will be appreciated by those skilled the art that obvious changes could be made to the embodiment described in the foregoing description without departing from the broad inventive concept thereof. For example, although the foregoing embodiment of the motion transfer mechanism has been described with a specific application to a tricycle, it will be appreciated that the invention is also particularly well adapted for other types of rider-propelled vehicles, such as, for example, bicycles, paddle boats, small aircraft, wheelchairs and skateboards, as well as other applications, such as, for example, exercise apparatus including stair climbers, stationary bicycles and other physical conditioning devices. It is understood, therefore, that this invention is not limited to the particular embodiment disclosed, but is intended to cover all modifications thereof which are within the scope and spirit of the invention as defined by the appended claims.

What is claimed is:

1. A motion transfer mechanism for transferring reciprocal motion to rotary motion, the motion transfer mechanism comprising:
a pair of driving members configured to undergo reciprocal motion about a first axis;
a pair of clutch housings configured to undergo angular displacement about the first axis during reciprocal motion of the respective driving members;
a driven member mounted to undergo rotary motion in first and second opposite directions of rotation about the first axis;
a first unidirectional clutch mechanism configured to engage the clutch housings for effecting rotation of the driven member in only the first direction of rotation during reciprocal motion of the driving members; and
a second unidirectional clutch mechanism configured to engage the clutch housings for effecting rotation of the driven member in only the second direction of rotation during reciprocal motion of the driving members.

2. A motion transfer mechanism according to claim 1; wherein each of the driving members has front and rear end portions terminating, respectively, in front and rear ends, the clutch housing being connected to the respective rear ends of the driving members.

3. A motion transfer mechanism according to claim 1; wherein the first unidirectional clutch mechanism is mounted on and is drivingly engaged with the driven member for undergoing rotary motion about the first axis during reciprocal motion of the driving members to effect rotation of the driven member in only the first direction of rotation; and wherein the second unidirectional clutch mechanism is mounted on and is drivingly engaged with the driven member for undergoing rotary motion about the first axis during reciprocal motion of the driving members to effect rotation of the driven member in only the second direction of rotation.

4. A motion transfer mechanism according to claim 3; wherein each of the first and second unidirectional clutch mechanisms comprises a pair of clutch rings each having a clutch element and a cylindrical friction block disposed within the clutch ring and integrally mounted on the driven member for rotation therewith, the clutch rings of the first unidirectional clutch mechanisms being configured for engagement with the respective clutch housings of the driving members in a first clutch engagement mode for effecting rotation of the driven member in only the first direction of rotation during reciprocal motion of the driving members, and the clutch rings of the second unidirectional clutch mechanisms being configured for engagement with the respective clutch housings of the driving members in a second clutch engagement mode for effecting rotation of the driven member in only the second direction of rotation during reciprocal motion of the driving members.

5. A motion transfer mechanism according to claim further comprising a clutch transfer mechanism for switching between the first clutch engagement mode and the second clutch engagement mode.

6. A motion transfer mechanism according to claim 5; wherein the driven member comprises a shaft having a plurality of recesses formed in an outer surface thereof and a plurality of ratchet keys protruding from and integrally mounted in the respective recesses for rotation therewith; and wherein the friction blocks of the first and second unidirectional clutch mechanisms are integrally mounted on the respective ratchet keys of the shaft for undergoing rotation with the shaft about the first axis and for undergoing sliding movement along the respective ratchet keys in the direction of the first axis.

7. A motion transfer mechanism according to claim 6; wherein the clutch transfer mechanism comprises a transfer member mounted to undergo linear movement in opposite directions along a second axis disposed generally parallel to the first axis, the transfer member having a plurality of engaging portions engaging with complementary engaging portions of the respective clutch rings of the first and second unidirectional clutch mechanisms so that movement of the transfer member in one direction to a first position along the second axis causes the clutch rings of the first unidirectional clutch assembly to slide along the respective ratchet keys and engage the respective clutch housings of the driving members, and so that movement of the transfer member in the opposite direction to a second position along the second axis causes the clutch rings of the second unidirectional clutch assembly to slide along the respective ratchet keys and engage the respective clutch housings of the driving members.

8. A motion transfer mechanism according to claim 7; wherein the clutch transfer mechanism further comprises a biasing member for biasing the transfer member to the first position.

9. A motion transfer mechanism according to claim 8; wherein the clutch transfer mechanism further comprises moving means for selectively moving the transfer member from the first position to the second position.

10. A motion transfer mechanism according to claim 7; wherein the second axis is disposed directly above the first axis.

11. A motion transfer mechanism according to claim 1; wherein each of the driving members has front and rear end portions terminating, respectively, in front and rear ends, the clutch housing being connected to the respective rear ends of the driving members; and wherein the front ends of the driving members are further from the first axis than are the rear ends.

12. A rider-propelled vehicle, comprising:
a frame;
a pair of driving members mounted on the frame to undergo reciprocal motion about a first axis;
a pair of clutch housings connected to the respective driving members for undergoing angular displacement about the first axis during reciprocal motion of the respective driving members;
a driven member mounted on the frame to undergo rotary motion in first and second opposite directions of rotation about the first axis;
a first unidirectional clutch mechanism mounted on the driven member and configured to engage the clutch housings for effecting rotation of the driven member in only the first direction of rotation during reciprocal motion of the driving members; and
a second unidirectional clutch mechanism mounted on the driven member and configured to engage the clutch housings for effecting rotation of the driven member in only the second direction of rotation during reciprocal motion of the driving members.

13. A rider-propelled vehicle according to claim 12; further comprising a pair of wheels mounted to opposite ends of the driven member for rotation therewith to propel the vehicle in a forward direction when the first unidirectional clutch mechanism engages the clutch housings during reciprocal motion of the driving members, and to propel the vehicle in a rearward direction when the second unidirectional clutch mechanism engages the clutch housings during reciprocal motion of the driving members.

14. A rider-propelled vehicle according to claim 12; wherein the first unidirectional clutch mechanism is mounted on and is drivingly engaged with the driven member for undergoing rotary motion about the first axis during reciprocal motion of the driving members to effect rotation of the driven member in only the first direction of rotation; and wherein the second unidirectional clutch mechanism is mounted on and is drivingly engaged with the driven member for undergoing rotary motion about the first axis during reciprocal motion of the driving members to effect rotation of the driven member in only the second direction of rotation.

15. A rider-propelled vehicle according to claim 14; wherein each of the first and second unidirectional clutch mechanisms comprises a pair of clutch rings each having a clutch element and a cylindrical friction block disposed within the clutch ring and integrally mounted on the driven member for rotation therewith, the clutch rings of the first unidirectional clutch mechanisms being configured for engagement with the respective clutch housings of the driving members in a first clutch engagement mode for effecting rotation of the driven member in only the first direction of rotation during reciprocal motion of the driving members, and the clutch rings of the second unidirectional clutch mechanisms being configured for engagement with the respective clutch housings of the driving members in a second clutch engagement mode for effecting rotation of the driven member in only the second direction of rotation during reciprocal motion of the driving members.

16. A rider-propelled vehicle according to claim 15; further comprising a clutch transfer mechanism for switching between the first clutch engagement mode and the second clutch engagement mode.

17. A rider-propelled vehicle according to claim 16; wherein the driven member comprises a shaft having a plurality of recesses formed in an outer surface thereof and a plurality of ratchet keys protruding from and integrally mounted in the respective recesses for rotation therewith; and wherein the friction blocks of the first and second unidirectional clutch mechanisms are integrally mounted on the respective ratchet keys of the shaft for undergoing rotation with the shaft about the first axis and for undergoing sliding movement along the respective ratchet keys in the direction of the first axis.

18. A rider-propelled vehicle according to claim 17; wherein the clutch transfer mechanism comprises a transfer member mounted to undergo linear movement in opposite directions along a second axis disposed generally parallel to the first axis, the transfer member having a plurality of engaging portions engaging with complementary engaging portions of the respective clutch rings of the first and second unidirectional clutch mechanisms so that movement of the transfer member in one direction to a first position along the second axis causes the clutch rings of the first unidirectional clutch assembly to slide along the respective ratchet keys and engage the respective clutch housings of the driving members, and so that movement of the transfer member in the opposite direction to a second position along the second axis causes the clutch rings of the second unidirectional clutch assembly to slide along the respective ratchet keys and engage the respective clutch housings of the driving members.

19. A rider-propelled vehicle according to claim 18; wherein the clutch transfer mechanism further comprises a biasing member for biasing the transfer member to the first position; and wherein the clutch transfer mechanism further comprises moving means for selectively moving the transfer member from the first position to the second position.

20. A motion transfer mechanism for transferring reciprocal motion to rotary motion, the motion transfer mechanism comprising:
at least one driving member configured to undergo reciprocal motion about a first axis;
at least one clutch housing integral with the at least one driving member and configured to undergo angular displacement about the first axis during reciprocal motion of the at least one driving member;
a driven member supporting the at least one clutch housing and mounted to undergo rotary motion in a direction of rotation about the first axis; and
at least one unidirectional clutch mechanism mounted on the driven member and configured to engage the at least one clutch housing for effecting rotation of the driven member in the direction of rotation during reciprocal motion of the at least one driving member.
